(19) United States
(12) Patent Application Publication
(10) Pub. No.: US 2019/0241753 A1
(43) Pub. Date: Aug. 8, 2019

(54) DURABLE SUPERHYDROPHOBIC AND SUPEROLEOPHOBIC COATINGS WITH NANOPARTICLES

(71) Applicant: BEIJING SANJU ENVIRONMENTAL PROTECTION & NEW MATERIALS CO., LTD., Beijing (CN)

(72) Inventors: Carol A. ELLIS-TERRELL, Schertz, TX (US); Ronghua Wei, San Antonio, TX (US)

(73) Assignee: BEIJING SANJU ENVIRONMENTAL PROTECTION & NEW MATERIALS CO., LTD., Beijing (CN)

(21) Appl. No.: 15/891,870

(22) Filed: Feb. 8, 2018

(51) Int. Cl. C09D 5/16; B05D 7/00; B05D 5/00; B05D 3/00; B01J 37/02; C09D 1/00; C09D 7/63

(52) U.S. Cl. CPC C09D 5/1681; B05D 7/582; B05D 5/00; C09D 7/63; B01J 37/0225; C09D 1/00; B05D 3/007

(57) ABSTRACT

A hydrophobic and oleophobic coating material, comprising: nanoparticles, comprising a metal oxide or a metalloid oxide and having a particle diameter ranging from 50 to 600 nm; with a functionalizing coating on the surfaces of said nanoparticles, said functionalizing coating comprising a compound having a haloalkyl moiety or a haloalkylsilane moiety. The hydrophobic and oleophobic coating material, when applied to a substrate, provides a coated substrate that is characterized by hydrophobicity having a water contact angle of 150° or more and oleophobicity having an oil contact angle of 150° or more.

This disclosure relates to coatings made of metal or metalloid nanoparticles that are characterized by superhydrophobicity and by superoleophobicity. The coatings are suitable for use on surfaces of machinery components, where the coatings reduce fluid drag both in laminar and in turbulent flow applications.

### BACKGROUND

In general, as-machined metal surfaces are both hydrophilic and oleophilic. Coatings are often applied to increase both the hydrophobicity and the oleophobicity of metal surfaces. So-called “superhydrophobic coatings” are particularly desirable in some applications.

Hydrophobicity is defined herein with regard to surface wetting property by water. If the water contact angle (“WCA”) is measured to be <90°, a surface is considered to be hydrophilic. In contrast, if the WCA is >90°, the surface is hydrophobic. If the WCA is >150°, the surface is superhydrophobic. Oleophobicity is defined herein with regard to surface wetting property by oil. If the oil contact angle (“OCA”) is measured to be <90°, a surface is considered to be oleophilic. In contrast, if the OCA is >90°, the surface is oleophobic. If the OCA is >150°, the surface is superoleophobic.

There are problems with regard to commercialization of superhydrophobic coatings. The problems include: 1) wetting issues, 2) durability, and 3) thermal stability. Known coatings tend to be unsatisfactory for industrial applications, especially where they are subjected to high degrees of abrasion or to very high temperatures. Thus, for instance, the coating compositions and performance disclosed in U.S. Pat. No. 9,279,073 and in U.S. Pat. No. 9,067,821 are not satisfactory when used in environments characterized by abrasive atmospheres and elevated temperatures.

U.S. Pat. No. 9,546,299 (“US '299”) defines superhydrophobicity and superoleophobicity in surfaces as being present when water and oil droplet contact angles on the surfaces exceed 150°.

The disclosure describes water-based binder systems having low volatile organic compound contents for coating nanoparticles. The disclosure in US '299 is concerned with particles having a wide range of particle sizes, including nano and micron size particles. The coatings disclosed in US '299 are relatively thick—in a range from about 10 microns to about 225 microns or in a range from about 30 microns to 350 microns. See column 9, lines 18-20. The coatings in US '299 employ water-based polyurethanes as binders.

### SUMMARY OF THE INVENTION

The present invention provides coatings in which nanoscale particles are strongly adhered to a targeted substrate. The inventive coatings are suitable for use on surfaces of machinery components, where the coatings reduce fluid drag both in laminar and in turbulent flow applications. For instance, the inventive coatings may be applied to the outsides of valves in internal combustion engines, to the inner surfaces of reactor vessels, and to the inner surfaces of pipes or tubular components used in the oil and gas industry for exploration, transmission, or refining oil or gas, in which the present coatings reduce problems associated with wax buildup. Also, the inventive coatings are suitable for use in covering an outer jacket of a transmission line to be used in the electric power industry. The inventive coatings create a water- and oil-repellant surface that is both abrasion-resistant and thermally stable.

The present invention focuses on coatings made only from nanoparticles. In contrast, the disclosure in US '299 is concerned with particles having a wide range of particle sizes. The present invention provides coatings that can be as thin as 5 microns and still maintain their hydrophobicity and oleophobicity, even after being subject to abrasion. In contrast to the present invention, moreover, the coatings disclosed in US '299 are relatively thick.

In one embodiment, the present invention provides a hydrophobic and oleophobic coating material which comprises nanoparticles with a functionalizing coating directly applied to the surfaces of the nanoparticles. The nanoparticles may comprise metal oxides or metalloid oxides. The nanoparticles will have an average particle diameter ranging from 50 to 600 nm. The functionalizing coating directly on the surface of said nanoparticles will comprise a compound having a haloalkyl moiety or a haloalkylsilane moiety.

When the inventive coating material is applied to a substrate, the coated substrate is characterized by hydrophobicity having a water contact angle of 150° or more and oleophobicity having an oil contact angle of 150° or more. The functionalized-nanoparticle-coated substrate may omit a binder, or may comprise a binder applied directly to the substrate and/or a binder which is present in between or mixed with the functionalized nanoparticles. The binder may comprise a silane coupling agent, an epoxy resin, or a fluoropolymer. Two or more different sizes of nanoparticles may be used to form the coating.

In another embodiment, the present invention provides a method of manufacturing the afore-mentioned hydrophobic and oleophobic coated substrate. The method includes the steps of: (a) applying a base coat (for instance, comprising N-(2-aminoethyl)-3-aminopropyl-trimethoxysilane in water) to the substrate; then (b) applying functionalized nanoparticles comprising a metal oxide or a metalloid oxide having a uniform particle diameter size ranging from 100 to 600 nm to the base-coated substrate; then (c) applying a base coat to the coated particles on the substrate; then (d) applying functionalized nanoparticles comprising a metal oxide or a metalloid oxide having a uniform average particle diameter ranging from 50 to 400 nni, wherein said uniform average particle diameter is smaller than the uniform average particle diameter applied in step (b), to the resulting base-coated particles on the substrate; then heat curing the coated substrate. Optionally, steps (c) and (d) may be repeated one or more additional times.

Additionally, a method of improving abrasion resistance of a coated substrate, which comprises coating the substrate with the coating material described above is contemplated. In this method of improving abrasion resistance, when the coated substrate is subjected to 100 abrasion cycles with a Taber Abrasion instrument at a 1000 gram load, a water droplet on the surface of said coated substrates still has a contact angle of at least 130°. In this method of improving abrasion resistance, when the coated substrate is subject to 100 abrasion cycles with a ball-on-disc system at a 50 gram load using a scouring pad as an abrading device, a water droplet and an oil droplet on the surface of said coated substrates still has a contact angle of at least 130°.

Applicant contemplates, furthermore, a method of improving heat resistance of a coated substrate, which comprises coating said substrate with the inventive coating material. In this method, after it has been heated up to 400° C., the coated substrate still exhibits hydrophobicity having a water contact angle of at least 150° and oleophobicity having an, oil contact angle of at least 150°.

Another method embodiment, for decreasing drag reduction in laminar or turbulent flow of a coated substrate, comprises coating the substrate with the above-described coating material. One application of this method contemplates coating a substrate which comprises the outside of a valve in an internal combustion engine, or the inner surface of a reactor vessel, or the inner surface of a pipe or a tubular component suitable for use in the oil or gas industry for exploration, transmission, or refining oil or gas. Another application of this method contemplates coating a substrate which comprises an outer jacket of a transmission line suitable for use in the electric power industry.

The present invention also provides a method of increasing resistance to fouling of a coated substrate, which comprises coating said substrate with the inventive coating material, and a method for generating spherical catalyst support material, which comprises applying the inventive coating material to an aluminum substrate.

### BRIEF DESCRIPTION OF THE DRAWINGS

The enclosed drawings are illustrative only, and are not limiting of the patented invention, which is limited only by the appended claims.

FIG. 1 is a schematic illustration of different coating methods contemplated by embodiments of the present invention.

FIG. 2A depicts a water contact angle on bare aluminum. FIG. 2B depicts a water contact angle on aluminum coated in accordance with embodiments of the present invention.

FIG. 3 depicts an oil contact angle on aluminum coated in accordance with embodiments of the present invention.

FIG. 4 depicts an abraded coated sample and a water contact angle after abrasion of a coated substrate.

FIG. 5 is a sketch of a customized abrasion test device.

FIG. 6 shows water and oil contact angles of samples after heating.

### DETAILED DESCRIPTION OF THE INVENTION

In one aspect of the present invention, coatings formed of nanoscale particles are strongly adhered to a targeted substrate. The resulting coating provides a water-repellant and oil-repellant surface that is abrasion-resistant and thermally stable.

### The Substrates

The substrates which may be employed in one aspect of the present invention may be rigid or flexible, and may be constituted of, for instance, metal, ceramic, glass, plastic, and so on. Typical metal substrates include steels (i.e., iron alloys), iron, chromium and its alloys, aluminum and its alloys, titanium and its alloys, nickel and its alloys, and so on. Typical ceramics are oxides, nitrides, silicides, or carbides of metals such as iron, chromium, aluminum, titanium, zirconium, and nickel.

The substrates to which the inventive coatings may be applied include, without limitation, the outsides of valves in internal combustion engines, the inner surfaces of reactor vessels, the inner surfaces of pipes or tubular components used in the oil and gas industry for exploration, transmission, or refining oil or gas, and the outer jackets of transmission lines used in the electric power industry.

### The Nanoparticles

The nanoparticles may be (i) particles of metals such as titanium, iron, zinc, and aluminum, (ii) particles of metal oxides such as titanium oxide, iron oxide, zinc oxide, and aluminum oxide, (iii) particles of metalloids such as boron, silicon, germanium, selenium, and tellurium, or (iv) particles of metalloid oxides such as boron oxide, silicon oxide, germanium oxide, selenium oxide, and tellurium oxide.

One embodiment of the present invention may employ nanoparticles that are commercially available. For instance, commercial silica nanoparticles such as Hydrophobic Aerosil®, available from Evonik Industries of Essen, Germany may be used. Alternatively, nanoparticles may be custom synthesized by the Stöber method for use in accordance with this invention. See Stöber et al, J. Colloid Interface Sci., 26, 62-69 (1968); Valipour Motlagh et al., Appl. Surf. Sci., 283, 636-647 (2013).

The nanoparticles may have average diameters ranging in size from 50 nanometers to 600 nanometers. The particles sizes may be determined utilizing dynamic light scattering (“DLS”). DLS is a widely known technique which can measure the translational diffusion coefficients of nanoparticles in solution by quantifying dynamic fluctuations in scattered light. Sizes and size distributions, in turn, can be calculated from the diffusion coefficients in terms of hydrodynamic diameter.

### Functionalizing the Nanoparticles

In accordance with embodiments of the present invention, both the commercial and the synthesized nanoparticles may be functionalized with haloalkyl- or perhaloalkyl-silanes in order to create a hydrophobic shell around the nanoparticle. Typical silanes which may be utilized include, without limitation, 3-(2,2,3,3,4,4,5,5-octafluoropentyloxy)propyltriethoxysilane, (heptadecafluoro-1,1,2,2-tetrahydrodecyl)trimethoxysilane, and tridecafluoro-1,1,2,2-tetrahydrooxyltrichlorosilane. The wetting properties of the nanoparticles are changed in this way to modify their surface chemistry and thereby enhance the hydrophobicity and oleophobicity of the nanoparticles.

### The Binder

A binder may be used in connection with the formation of the inventive coating on a substrate. The binder may be, for instance and without limitation, a silane coupling agent, an epoxy resin, or a fluoropolymer. It has been found that silane coupling agents comprising alkoxysilanes containing aminoalkyl groups are particularly suitable for use as binders in the present invention. Examples of such compounds include, without limitation:
3-aminopropyltriethoxysilane,
3-(2-aminoethylamino)propyltrimethoxysilane,
3-(2-aminoethylamino)propyldimethoxymethylsilane,
3-(2-aminoethylamino)propyltriethoxysilane,
3-aminopropyldimethoxymethylsilane,
[3-(6-aminohexylamino)propyl]trimethoxysilane,
bis[3-(trimethoxysilyl)propyl]amine,
3-aminopropyldiethoxymethylsilane,
[3-(N,N-dimethylamino)propyl]trimethoxysilane,
trimethoxy[3-(phenylamino)propyl]silane,
3-aminopropyltrimethoxysilane, and
N-(2-aminoethyl)-3-aminopropyl-trimethoxysilane.

Such silane coupling agents can be used alone or in combination with one another and/or with other binders. It has been found that the compound N-(2-aminoethyl)-3-aminopropyl-trimethoxysilane provides exceptionally good results when employed as a binder in the present invention.

### Applying the Coating

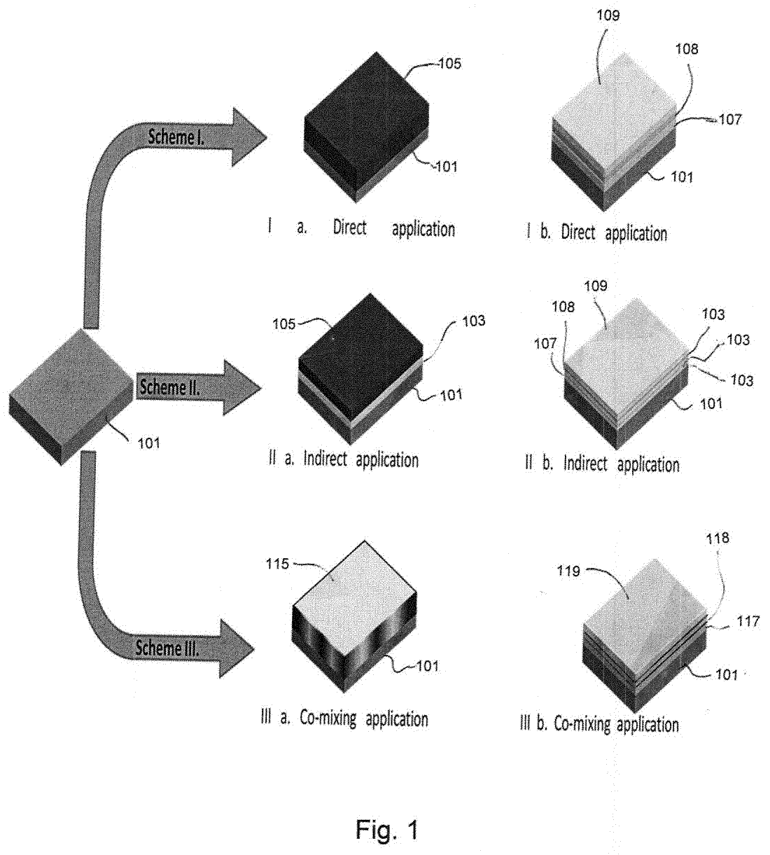

As illustrated in Scheme I in FIG. 1, direct application of the coating to a substrate 101 may result in a single layer 105 of functionalized nanoparticles having mixed diameters in the range 50-600 nanometers, or, alternatively, for instance, three layers of functionalized nanoparticles of three different size ranges, all three falling within the 50-600 nm overall range. As an example, one group of nanoparticles 109 may have average diameters falling within the range 50-200 nm, a second group of nanoparticles 108 may have average diameters falling within the range 200-300 nm, and a third group of nanoparticles 107 may have average diameters falling within the range 300-600 nm. Typically in this embodiment, the first layer 107 (i.e., the layer closest to the substrate) would be made of the largest functionalized nanoparticles and the layer furthest away from the substrate 109 would be made of the smallest functionalized nanoparticles. In this embodiment, the single-layered coating can be applied multiple times to achieve the desired coating thickness, while in the case of the tri-layered coating, each layer can be applied multiple times. Typically, each layer within the coating will be at least about 1 micron in thickness and the total thickness of the coating will range from 5 microns to 300 microns.

As an alternative to direct application, indirect application of the coating may be carried out, in which a binder is applied to the surface of the substrate, forming a base coat on the substrate, followed by application of the functionalized nanoparticles. As discussed above, the binder may be a silane coupling agent, an epoxy resin, or a fluoropolymer. Once applied to a substrate or to a layer of nanoparticles on a substrate, the binder constitutes a base coat.

Following application of the base coat 103 onto the substrate 101, as shown in Scheme IIa of FIG. 1, a single-layered coating 105 consisting of functionalized nanoparticles with multiple average diameters, or functionalized nanoparticles having the same average diameter may be applied. Alternatively, as shown in Scheme IIb of FIG. 1, nanoparticles with the largest average diameters 107 may be applied following the application of a base coat 103. This may be followed by a second layer of base coat or binder 103 and then a second layer of nanoparticle having medium average diameters 108. Finally, a third base coat or binder 109 may be applied and the third layer 109 of nanoparticles, with the smallest average diameters, may be applied. Each layer can be applied multiple times to achieve the desired coating thickness. Typically, each layer within the coating will be at least about 1 micron in thickness and the total thickness of the coating will range from 5 microns to 300 microns.

In another embodiment, the coating may be applied using a co-mixing application in which nanoparticles are mixed with a binder prior to application to the surface. The binder plus the functionalized nanoparticles with multiple average diameters, in the range 50-600 nm, may be applied to form a single layered coating 115 (1 micron to 300 microns), as shown in Scheme IIIa of FIG. 1. Or, the binder may be mixed with the functionalized nanoparticles of three different average diameters separately. Then the mixture 117 of the binder with the largest average particle diameters (350 nm to 600 nm) may be applied first, followed by the mixture 118 of the binder with nanoparticle having medium average particle diameters (200 nm to 350 nm), and finally by the mixture 119 of the binder with the smallest average particle diameters (50 nm to 200 nm). See Scheme IIIb of FIG. 1. Each layer may be applied multiple times to achieve the desired coating thickness. Typically, each layer within the coating will be at least about 1 micron in thickness and the total thickness of the coating will range from 5 microns to 300 microns.

In other embodiments of the coating processes, after the coating is applied, one or more forms of curing may take place—for instance, thermal curing, curing using a heat gun, vacuum oven curing, UV curing, etc. In some cases, the substrate may be pre-heated to a temperature in the range 70° C. to 90° C. to aid in curing upon application of the coating.

### EXAMPLES

### Superhydrophobic and Superoleophobic Coating

Smooth aluminum coupons were coated with the superhydrophobic nanoparticle coating using method II(a)—that is, a base coat was applied to the substrate, and then superhydrophobic nanoparticles were applied onto the coated substrate. The base coat used in this testing was a silane coupling agent, specifically, a 1:2 weight ratio mixture of N-(2-aminoethyl)-3-aminopropyl-trimethoxysilane to water. The silicon nanoparticles were prepared using the Stöber method, mentioned above. The chemicals employed for coating the nanoparticles were tetraethoxysilane (TEOS), acetone, ammonium hydroxide, and deionized water. No further purification of the chemicals was carried out.

The sizes of the functionalized nanoparticle used were adjusted based on the concentration of the ammonium hydroxide. Nanoparticles having three different average diameters were prepared: 340 nm, 260 nm, and 160 nm. The nanoparticle solutions were mixed with (heptadecafluoro-1,1,2,2-tetrahydrodecyl)trimethoxysilane to create hydrophobic shell around the nanoparticles. Then the solutions with the nanoparticles were sprayed onto the aluminum coupons with the largest nanoparticles being applied first (340 nm) followed by the medium nanoparticles (260 nm) and then the smallest nanoparticles (160 nm). After all the nanoparticles were applied to the aluminum coupon, the material was then cured with a heat gun. In one embodiment, the total thickness of the coating may be 6 μm and the thickness of each layer may be 2 μm.

The water contact angle (“WCA”) and the oil contact angle (“OCA”) of the coated samples were measured using the sessile drop method. The contact angle is defined as the angle made by the intersection of the liquid/solid interface and the liquid/air interface. It can be alternately described as the angle between solid sample's surface and the tangent of the droplet's ovate shape at the edge of the droplet. A high contact angle indicates a low solid surface energy or chemical affinity (a low degree of wetting). A low contact angle indicates a high solid surface energy or chemical affinity (a high degree of wetting). In the sessile drop method, the contact angle of a sessile drop is measured with a contact angle goniometer, which allows the user to measure the contact angle visually. A droplet is deposited by a syringe which is positioned above the sample surface, and a high resolution camera captures the image from the profile or side view. The image is then analyzed using image analysis software to determine the contact angle.

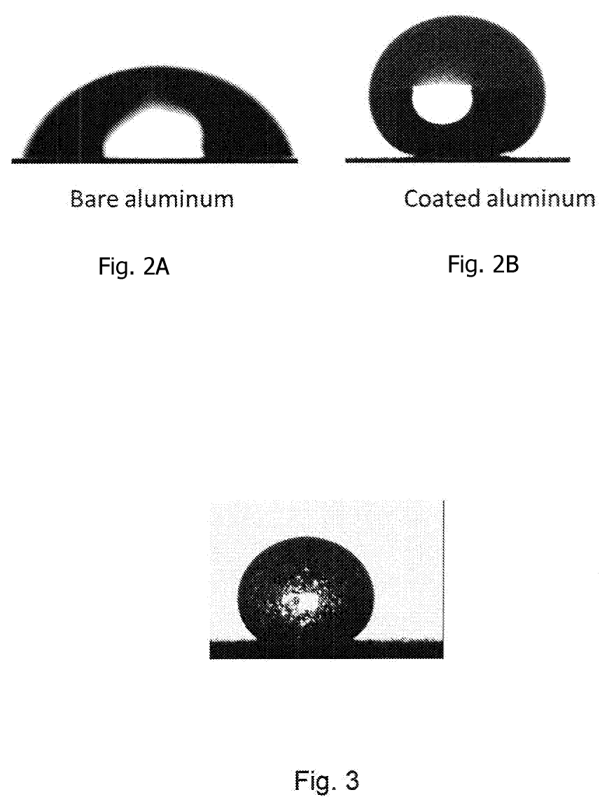

The WCA for the smooth aluminum without any coating was measured to be approximately 70° using the sessile drop method. After the superhydrophobic coating was applied, the water droplet formed a sphere and rolled off of the surface of the aluminum coupon. In the regions where the droplet was measurable, the water contact angle was approximately 160°. These results are depicted in FIG. 2.

The sessile drop method was used to determine the oil contact angle (OCA). The oil used to measure the OCA was Pennzoil® 5W-20. The OCA for the uncoated smooth aluminum was not measurable, since the oil completely wetted the surface. The OCA increased significantly on the smooth aluminum surface after the superoleophobic coating was applied. The oil droplet beaded up and the OCA was measured to be approximately 156°, as shown in FIG. 3.

### Mechanical Durability of Coating

Aluminum alloy 2024 is an aluminum alloy with copper as the primary alloying element. It is used in applications requiring high strength to weight ratio, as well as good fatigue resistance. Due to its poor corrosion resistance, it is often coated. Aluminum 2024 is commercially available, for instance from: ASM Aerospace Specification Metals Inc. of Pompano Beach, Fla.; Midwest Steel and Aluminum of New Hope, Minn.; Rickard Specialty Metals and Engineering of Ontario, Calif.; and Premier Metals, Inc. of Gardena, Calif.

In order to assess the mechanical durability of the coating, wear tests were conducted on 2024 smooth aluminum substrates to which the superhydrophobic nanoparticle coating was applied using method II(b)—that is, a binder (base coat) was applied to the substrate, then large superhydrophobic nanoparticles (˜340 nm) were applied onto the coated substrate, then more binder was applied over the large particles, and then medium-size superhydrophobic nanoparticles (˜260 nm) were applied onto the resulting coated substrate, and finally still more binder was applied, followed by the application of small superhydrophobic nanoparticles (˜160 nm) over the resulting coated substrate. The binder used in this testing was a silane coupling agent, specifically, a 1:2 weight ratio mixture of N-(2-aminoethyl)-3-aminopropyl-trimethoxysilane to water. After applications of binder and nanoparticles, the coating was cured using a heat air gun. Then the coated coupons were subjected to Taber abrasion tests, and to customized abrasion tests as discussed below. After each test, the water contact angles and the oil contact angles were measured.

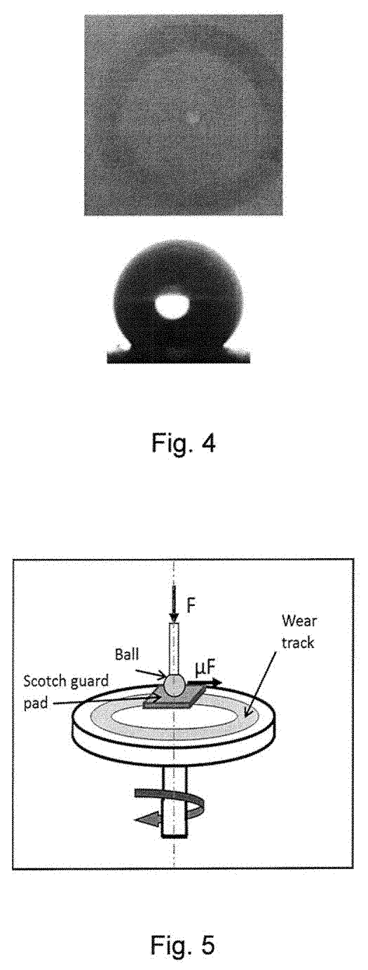

The Taber abrasion test was conducted in accordance with ASTM D4060, Standard Test Method for Abrasion resistance of Organic Coatings by the Taber Abraser. The Taber® Linear Abraser (Abrader), Model 5740, is an instrument available from Taber Industries of North Tonawanda, N.Y. A load of 1000 grams was applied to abrade the surface 100 cycles. The average water contact angle after 100 cycles was approximately 140°, which is still quite high for many applications. An image of the abraded surface and contact angle measured in the abraded area is depicted in FIG. 4.

To demonstrate that the coating was durable against conventional abrading tools used for cleaning, a customized abrasion test was designed. The test set-up employed a ball-on-disc tribometer with a scouring pad. To ensure that a constant load was applied to the surface, the ball-on-disc system was modified and the scouring pad was attached to the bottom of the ball. The set-up is illustrated in FIG. 5. The scouring pad was sized to approximately ½″×½″ and a load of 50 grams was applied at 39 rpm to the substrate surface. Water contact angle measurement after 100 cycles was 137°, still high enough for many applications.

### Thermal Stability of the Coating

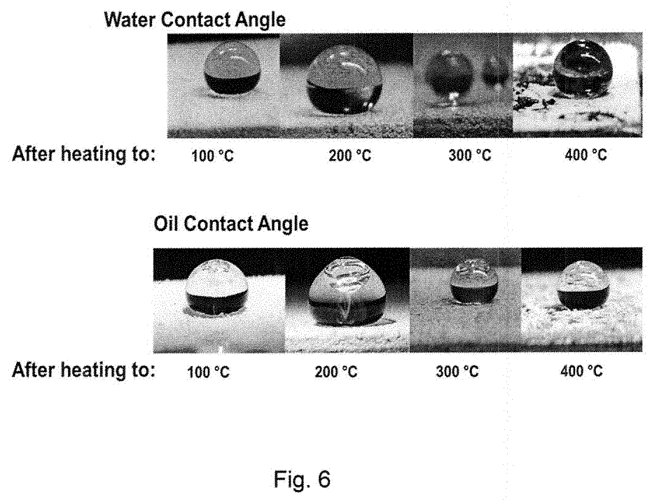

The thermostability of the coatings, which were prepared using the same method as those used in the abrasion tests (method IIb), was assessed at 100° C. up to 400° C. Both the hydrophobicity and oleophobicity of the coating were evaluated after heating, as shown in FIG. 6. The water contact angle improved with an increase in temperature 300° C., where the water bounced on all portions of the surface. At 400° C., the water contact angle was decreased to 150°, which is still superhydrophobic. The oil contact angle was consistent from 100° C. to 400° C. It was measured as being approximately 151°, which is superoleophobic.

Although specific embodiments of the invention are illustrated and described herein, it will be appreciated by those skilled in the art that a variety of alternate and/or equivalent implementations exist. It should be appreciated that the exemplary embodiment or exemplary embodiments are examples only, and are not intended to limit the scope, applicability, or configuration in any way. Rather, the foregoing summary and detailed description will provide those skilled in the art with a convenient roadmap for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

What is claimed is:

1. A hydrophobic and oleophobic coating material, comprising:
nanoparticles, comprising a metal oxide or a metalloid oxide and having an average particle diameter ranging from 50 to 600 nm; and
a functionalizing coating directly applied to a surface of said nanoparticles, said coating comprising a compound having a haloalkyl moiety or a haloalkylsilane moiety,
wherein said coating material, when applied to a substrate, exhibits hydrophobicity having a water contact angle of 150° or more and oleophobicity having an oil contact angle of 150° or more, and wherein said substrate does not comprise a binder, or comprises a binder applied directly to the substrate and/or comprises a binder present in between or mixed with the functionalized nanoparticles.

2. The coating material of claim 1, wherein said binder is present and comprises a silane coupling agent, an epoxy resin, or a fluoropolymer.

3. The coating material of claim 2, wherein said binder comprises an alkoxysilane containing an aminoalkyl group.

4. The coating material of claim 3, wherein said binder comprises N-(2-aminoethyl)-3-aminopropyl-trimethoxysilane.

5. The coating material of claim 1, wherein two or more different sizes of nanoparticles are used to form the coating.

6. A method of manufacturing a hydrophobic and oleophobic coated substrate, the coating on the substrate comprising nanoparticles comprising a metal oxide or a metalloid oxide having an average particle diameter ranging from 50 to 600 nm and a functionalizing coating applied to a surface of said nanoparticles, the coating on the nanoparticles comprising a compound having a haloalkyl moiety or a haloalkylsilane moiety, wherein said substrate coating material, when applied to the substrate, exhibits hydrophobicity having a water contact angle of 150° or more and oleophobicity having an oil contact angle of 150° or more, said method comprising:
(a) applying a base coat to the substrate; then
(b) applying functionalized nanoparticles comprising a metal oxide or a metalloid oxide having a uniform particle diameter size ranging from 100 to 600 nm to the base-coated substrate; then
(c) applying a base coat to the coated particles on the substrate; then
(d) applying functionalized nanoparticles comprising a metal oxide or a metalloid oxide having a uniform average particle diameter ranging from 50 to 400 nm, wherein said uniform average particle diameter is smaller than the uniform average particle diameter applied in step (b), to the resulting base-coated particles on the substrate; then
(e) heat curing the coated substrate.

7. The method of claim 6, wherein the base coating material comprises N-(2-aminoethyl)-3-aminopropyl-trimethoxysilane in water, and wherein steps (c) and (d) are repeated one or more additional times.

8. A method of improving abrasion resistance of a coated substrate, which comprises coating said substrate with the coating material of claim 1.

9. The method of claim 8, wherein, when the coated substrate is subjected to 100 abrasion cycles with a Taber Abrasion instrument at a 1000 gram load, a water droplet on the surface of said coated substrates has a contact angle of at least 130°.

10. The method of claim 8, wherein, when the coated substrate is subject to 100 abrasion cycles with a ball-on-disc system at a 50 gram load using a scouring pad as an abrading device, a water droplet and an oil droplet on the surface of said coated substrates has a contact angle of at least 130°.

11. A method of improving heat resistance of a coated substrate, which comprises coating said substrate with the coating material of claim 1.

12. The method of claim 11, wherein the coated substrate, after being heated up to 400° C., exhibits hydrophobicity having a water contact angle of at least 150° and oleophobicity having an oil contact angle of at least 150°.

13. A method of decreasing drag reduction in laminar or turbulent flow of a coated substrate, which comprises coating said substrate with the coating material of claim 1.

14. The method of claim 13, wherein said substrate comprises the outside of a valve in an internal combustion engine, the inner surface of a reactor vessel, or the inner surface of a pipe or a tubular component suitable for use in the oil or gas industry for exploration, transmission, or refining oil or gas.

15. The method of claim 13, wherein said substrate comprises an outer jacket of a transmission line suitable for use in the electric power industry.

16. A method of increasing resistance to fouling of a coated substrate, which comprises coating said substrate with the coating material of claim 1.

17. A method for generating spherical catalyst support material, which comprises applying the coating material of claim 1 to an aluminum substrate.
